(19) United States
(12) Patent Application Publication
(10) Pub. No.: US 2023/0225268 A1
(43) Pub. Date: Jul. 20, 2023

(54) WATER RECYCLING SYSTEM FOR A PERMEABLE GROW BAG POT

(71) Applicants: Koshy Cherian, Chapel Hill, NC (US); Kuruvilla Kurian, Burlington, NC (US)

(72) Inventors: Koshy Cherian, Chapel Hill, NC (US); Kuruvilla Kurian, Burlington, NC (US)

(21) Appl. No.: 17/577,253

(22) Filed: Jan. 17, 2022

(51) Int. Cl. A01G 27/06

(52) U.S. Cl. CPC A01G 27/06

(57) ABSTRACT

A system enabling the recycling of the runoff water and nutrients by a self-wicking mechanism back into the growing media in a controlled and sustained manner. This process of recycling of the runoff provides the plant with optimum hydration, nutrient supply and aeration of the growth media thus eliminating hypoxia and resulting in increased biomass and fruit and/or flower production.

### CROSS-REFERENCES TO RELATED APPLICATIONS

This application claims the benefit of provisional application No. 63/138,450 entitled WATER RECYCLING SYSTEM FORA PERMEABLE GROW BAG POT, filed Jan. 17, 2021. The provisional application is incorporated in its entirety by reference.

### FIELD OF INVENTION

The present invention relates generally to apparatus and method of use for a plant growing container. More particularly, the present invention is related to an improved design for water-retaining grow bags/pots.

### BACKGROUND OF THE INVENTION

Water consumption by the growing plants tax the environment in regions with scarce water supply. Each potted plant could consume from 3-6 liters of water/day depending on the foliage size. While watering potted plants, the majority of water is lost in the runoff. Additionally, this runoff causes loss of nutrients. This is especially true with the grow bags, since this water loss is accentuated by the rapid evaporation facilitated by the porous nature of the grow bag. Although porous fabric improves root pruning by drying out the root tips, over time, this feature could limit the absorption of water and nutrients.

In the past, various attempts have been made to solve the issue of dehydration of root tips such as placing the grow bag in a water bath, installing drip irrigation directly to the root, frequent low volume watering by setting timer, etc. Although the above methods fixed some of the challenges, there was no one method that solved it all, and were not economical, and or user-friendly. In addition, they resulted in problems such as over watering, root rotting, and the constant high level of moisture resulted in unsightly moss and/or mold growth in the growing medium and/or on the outer surface of the grow bags, which reduced their appeal for indoor usage. Conventional grow bag systems have likewise required constant watering due to water runoff and evaporation through the permeable fabric. In addition, conventional grow bag systems fail to maintain optimum temperature of the growing medium.

Household gardening has been improved due to the introduction of the permeable grow bags, but this does not solve the problem of runoff water and nutrients from the growing medium. In fact, the biggest challenge in home gardening continues to be the demand for frequent watering of the plants due to the lack of a system which will reduce or eliminate the water & nutrient run off and reduce hypoxia of the roots by ensuring adequate oxygen supply to the roots.

It may, therefore, be advantageous to provide an improved design for water-retaining grow bags/pots.

### SUMMARY OF THE INVENTION

This Summary is provided to introduce a selection of concepts in a simplified form that is further described below in the Detailed Description. This Summary is not intended to identify key features or essential features of the claimed subject matter, nor is it intended to be used as an aid in determining the scope of the claimed subject matter. The present invention is defined by the claims.

The present invention is directed towards apparatus and methods of use of a runoff recycling system enabling the usage of irrigation and rainfall water and runoff nutrients through capillary action, further enhanced by the increased evaporation through the fully permeable pot.

The embodiments of the present invention include a system enabling the recycling of the runoff water and nutrients by a self-wicking mechanism back into the growing media in a controlled and sustained manner. This process of recycling of the runoff provides the plant with optimum hydration, nutrient supply and aeration of the growth media thus eliminating hypoxia and resulting in increased biomass and fruit and/or flower production.

### BRIEF DESCRIPTION OF THE DRAWINGS

The present invention is described in detail below with reference to the attached drawing figures, wherein:

FIG. 1 provides a perspective view of an exemplary embodiment of a water recycling system for a permeable pot in accordance with aspects of the present invention.

FIG. 2 provides an exploded view of an exemplary embodiment of a water recycling system in accordance with aspects of the present invention.

FIG. 3 provides a cross section view of an exemplary embodiment of a water recycling system in accordance with aspects of the present invention.

FIG. 4 provides a detail view of an exemplary embodiment of a linear stem for a water recycling system in accordance with aspects of the present invention.

FIG. 5 provides a perspective view of an exemplary embodiment of a permeable pot in accordance with aspects of the present invention.

FIG. 6 provides a perspective view of an exemplary embodiment of a runoff collecting basin lid with single cone support in accordance with aspects of the present invention.

FIG. 7 provides a perspective view of an exemplary embodiment of a runoff collecting basin in accordance with aspects of the present invention.

### DETAILED DESCRIPTION OF THE INVENTION

Some embodiments of the present invention are described with specificity herein to meet statutory requirements. However, the scope of the invention is not intended to be defined by the description itself. The claimed subject matter may be embodied as to include different features, elements, components, steps, or combinations of steps, similar to those described herein, and in combination with other existing or future technologies. Moreover, although the term “step” might be used to connote different elements of the methods employed, this term should not be interpreted as implying any particular order among or between various steps herein disclosed unless and except the order of individual steps is explicitly described or required.

Embodiments of the present invention may recycle the runoff water and nutrients into the plant's growing medium through a self-wicking mechanism. In this way, embodiments of the present invention may enable the growing medium to retain moisture longer, thus resulting in better nutrient absorption and luscious plant growth. The growing medium may include, but is not limited to, soil, compose, mulch, vermiculite, zeolite, pumice, peat moss, coconut coir, clay balls or pebbles, sand, silt, or the like, or combinations thereof. Some embodiments of the present invention may collect the runoff water into a reservoir attached to the underside of the grow bag, which is then recycled back to the growing medium through a central self-wicking column through capillary action. The rate of water absorption may be controlled by the plant's hydration needs, thus preventing dehydration, water logging and rotting of roots and eliminates the moss growth on the outer surface of the bag.

Embodiments of the present invention may enable the recycling of the runoff water and nutrients by a self-wicking mechanism back into the growing media in a controlled and sustained manner. This process of recycling of the runoff may provide the plant with optimum hydration, nutrient supply and aeration of the growth media thus eliminating hypoxia and resulting in increased biomass and fruit/ flower production. The increased soil aeration and moisture retention features may bolster root pruning and root nutrition, optimizing the yield while conserving resources such as water and soil nutrients.

Embodiments of the present invention may incorporate a self-watering apparatus to the traditional grow bag. Embodiments of the present invention may be designed as a cloth grow bag with a central opening at the bottom, through which a central wicking column may be inserted.

The centrally located water wicking column enables consistent hydration and minimizes water loss. This central wicking column may be attached to the lid of a runoff collecting basin. In some embodiments, the runoff collecting basin may be designed to store water.

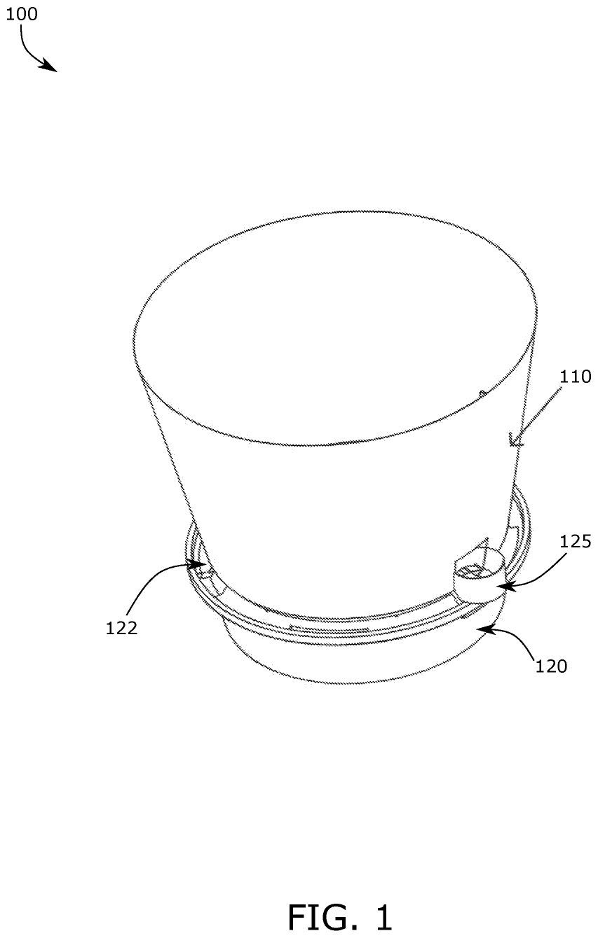

FIG. 1 provides a perspective view 100 of an exemplary embodiment of a water recycling system for a permeable pot in accordance with aspects of the present invention. As depicted, permeable pot 110 has a curved edge and a central opening in the bottom (not shown in this view). Runoff collecting basin 120 includes lid 122. Basin 120 may be made of polypropylene. Lid 122 also has a central opening (not shown in this view) aligned with the central opening at the bottom of permeable pot 110. Spout 125, attached to the side of basin 120 allows a user supply water to the basin.

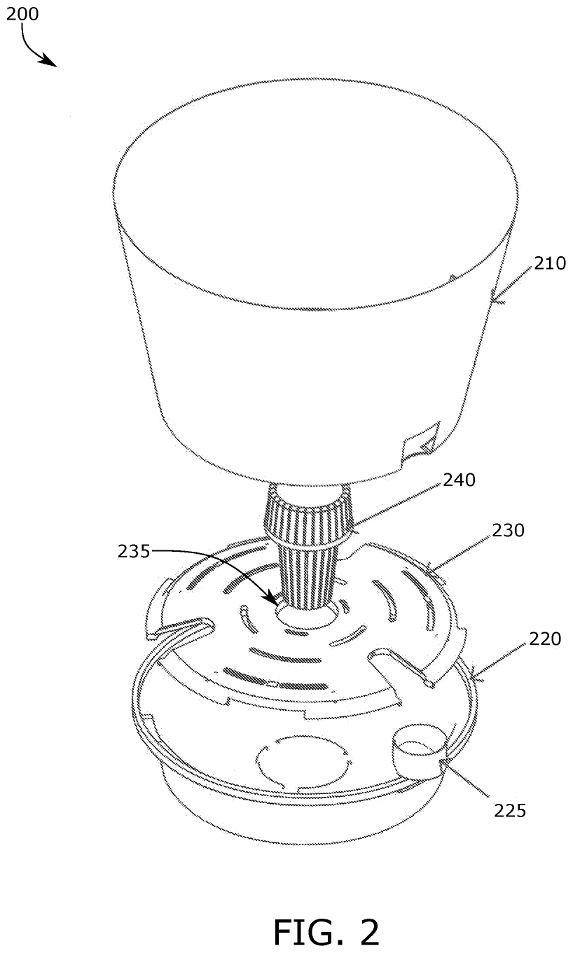

FIG. 2 provides an exploded view 200 of an exemplary embodiment of a water recycling system in accordance with aspects of the present invention. As depicted, water permeable grow bag 210 sits above basin 220. Basin 220 is configured to collect water that runs off from grow bag 210. Basin 220 includes spout 225, through which water may be added to basin 220. Basin lid 230 sits on top of basin 220 and provides a base for grow bag 210 to rest. Basin lid 230 include central opening 235 through which wicking column 240 passes. Wicking column 240 is configured to draw water from basin 220 into grow bag 210.

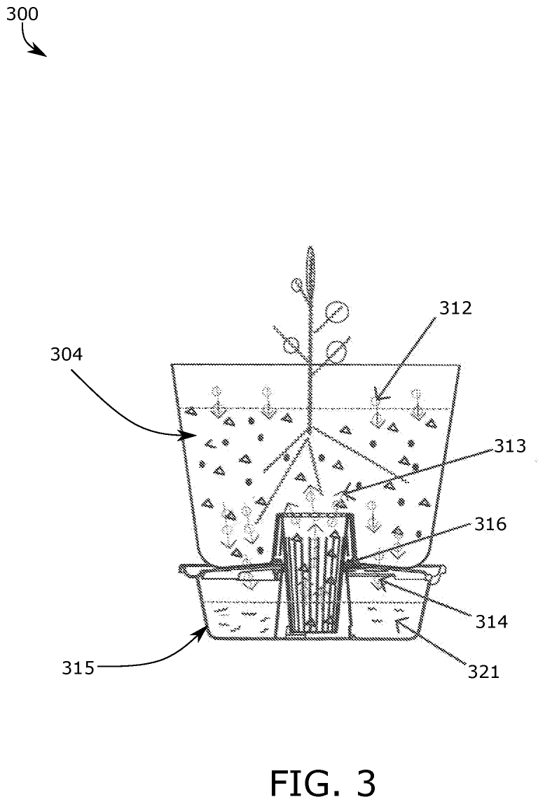

FIG. 3 provides a cross section view 300 of an exemplary embodiment of a water recycling system in accordance with aspects of the present invention. As depicted, growing medium 304 may be irrigated from above 312. As growing medium 304 becomes saturated, excess water 314 may matriculate downward and collect in basin 315, carrying with it nutrients found in growing medium 304. Collected water 321 may then contact wicking column 316. Wicking column 316 may provide a pathway for collected water 312 in basin 315 to be absorbed into growing medium 304 through capillary action. Returned water 313 thus rehydrates growing medium 304 and returns any nutrients removed by excess water 314.

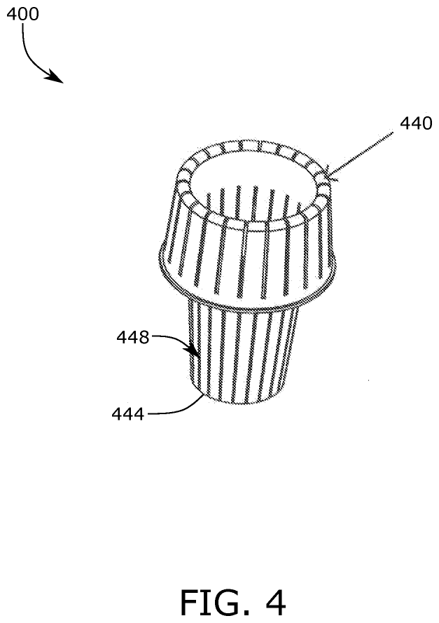

FIG. 4 provides a detail view 400 of an exemplary embodiment of a wicking column for a water recycling system in accordance with aspects of the present invention. As depicted, the wicking column 440 may comprise a linear stem 444 taking the form of a conical section and having groves and/or slits 448 cut therein to induce capillary action. In some embodiments, the wicking column 440 make comprise a material having inherent wicking properties including but not limited to wood, ratan, bamboo, cotton, polyester batting, or the like.

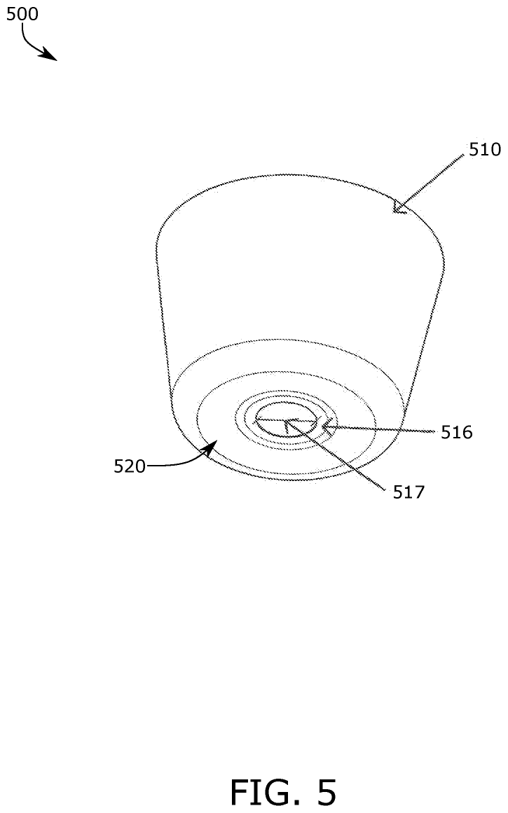

FIG. 5 provides a perspective view 500 of an exemplary embodiment of permeable pot 510 in accordance with aspects of the present invention. Rim reinforcement 516 to hold permeable pot 510 to the basin lid (not shown). The permeable pot 510 may comprise a permeable cloth grow bag or pot with a central opening 517 in base 520 for water recycling. The central location of central opening 517 may provide more uniform hydration of the grow medium within permeable pot 510. Further, the single central opening 517 is configured to house a single wicking column (not shown). The use of a single wicking column may be easily replaced as needed without requiring replacement of multiple components.

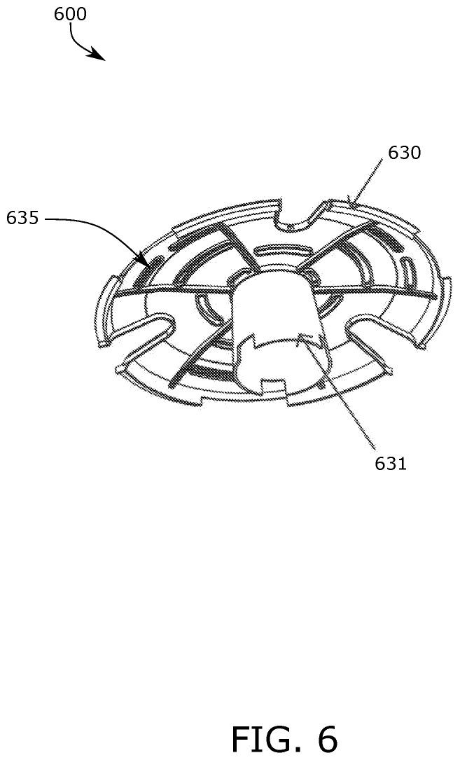

FIG. 6 provides a perspective view 600 of an exemplary embodiment of a runoff collecting basin lid 630 with single cone support leg 631 in accordance with aspects of the present invention. Basin lid 630 is designed to stably support a permeable planting pot with curve edge and base (not shown). Support leg 631 is configured to support the runoff collecting basin lid 630 and prevent the wicking column (not shown) from warping from the weight of the grow bag filled with growing medium (not shown). In some embodiments, runoff collecting basing lid 630 may include perforations 635. Perforation 635 may increases air circulation through the bottom of the growing media thus eliminating hypoxia in the growing media.

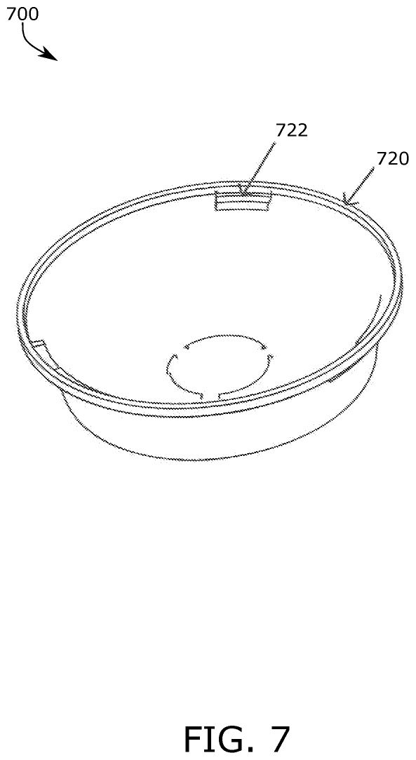

FIG. 7 provides a perspective view 700 of an exemplary embodiment of a runoff collecting basin 720 in accordance with aspects of the present invention. The runoff collecting basin 720 may comprise but is not limited to a thermoplastic polymer such as polypropylene or the like, bagasse, bioplastic, bamboo or similar material treated to be water-impermeable, stainless steel, silicone, ceramic, glass, or similar materials. As depicted, basin 720 includes overflow path 722 to control and direct excess water.

In some embodiment of the present invention, excess water runoff is directed from the growth medium into the permeable pot to the collecting basin. The central inlet attached to the lid enables recycling through capillary action, lifting the water and nutrients through the center of the pot ensures optimum sustained hydration of the growing media. The recirculation of water minimizes the effect of water loss due to evaporation and runoff through the permeable walls of the pot. The perforated spout and the lid of the base runoff collecting basin increases air circulation through the bottom of the growing media thus eliminating hypoxia in the growing media.

Embodiments of the present invention have been described, as required by statute, to be illustrative, but should not be interpreted to be restrictive. One having skill in the art will recognize that many different arrangements of the various components depicted are possible without departing from the scope of the claims below, as well as arrangements including components not explicitly shown.

One having skill in the art will understand that certain combinations and/or sub-combinations of elements and features are of utility and may be employed without reference to other combinations and/or sub-combinations and are contemplated within the scope of the claims. Not all steps listed in the various figures need be carried out in the specific order described.

What is claimed is:

1. A runoff recycling system comprising:
a permeable pot configured to hold growth medium, wherein the permeable pot includes a bottom having a central opening;
a collecting basin configured to hold water having a spout;
a wicking column configured to recycle water from the collecting basin into the permeable pot through capillary action; and
a collecting basin lid configured to sit on top of the collecting basin,
wherein the collecting basin lid includes a central inlet configured to receive the wicking component.
